(19) United States
(12) Patent Application Publication
(10) Pub. No.: US 2020/0364585 A1
(43) Pub. Date: Nov. 19, 2020

(54) MODULAR FEATURE EXTRACTION FROM PARSED LOG DATA

(71) Applicant: Oracle International Corporation, Redwood Shores, CA (US)

(72) Inventors: PAVAN CHANDRASHEKAR, Vancouver (CA); ANDREW BROWNSWORD, Bowen Island (CA); MANEL FERNANDEZ GOMEZ, Barcelona (ES); JUAN FERNANDEZ PEINADOR, Barcelona (ES); ROD REDDEKOPP, Surrey (CA)

(21) Appl. No.: 16/414,990

(22) Filed: May 17, 2019

(51) Int. Cl. G06N 5/04; G06N 20/00

(52) U.S. Cl. CPC G06N 5/04; G06N 20/00

(57) ABSTRACT

Herein are techniques for efficient and modular transcoding of message fields into features for inclusion within a feature vector. In an embodiment, a computer receives message signatures. Each signature has fields. Each field has a name and type. A feature map is generated that associates a field name and field type with transcoder(s). A message is received from a parser as field tuples. Each tuple has a type, name, and value of a field. Each tuple is processed as follows. The field name and field type of the tuple is used as a lookup key into the feature map to retrieve respective transcoder(s) that each generate a respective encoded feature from the field value of the tuple. An encoded feature from at least one relevant transcoder is written into a respective distinct location within a feature vector to encode the message. An inference is made based on the feature vector.

### RELATED CASES

Incorporated by reference is related U.S. patent application Ser. No. 16/246,765 “Parsing of Unstructured Log Data into Structured Data and Creation of Schema” filed Jan. 14, 2019, by Rod Reddekopp et al.

### FIELD OF THE INVENTION

The present invention relates to feature encoding of log messages. Herein are techniques for efficient and modular transcoding of message fields into features for inclusion within a feature vector.

### BACKGROUND

Machine learning (ML) algorithms typically need numeric representations of wild data as input. Data may naturally occur in types and structures that are not numeric such as text, network addresses, dates/times, pictures, videos and the like. The problems that techniques herein address may be part of a larger problem such as using a computer to detect abnormal or anomalous activity in a system. To achieve this, the computer may need access to descriptions of activities in the system.

System activities are typically logged or saved in text files such as system log files. The content of those files may include time information, network addresses, server names, file names, user identifiers, details of commands executed, errors or warnings thrown by a system in response to user activity or commands, and more. Much or all of that information may be encoded as text for ease of human consumption because, historically, humans have been the consumers of that data. While text representation and natural language are conducive for humans, those formats may be confusing or inefficient for machines. For example, text representations may lack type and structure information of original data which would have been very useful for a computer to understand and characterize a system activity. While there are some examples of semi-structured log formats, they are exceptions.

Prototyping solutions such as scikit-learn (sklearn) are unsuited for high volume production deployment because of architectural limitations that may degrade performance. For example, sklearn is unready for streaming as follows. Sklearn feature extraction is sufficient only for laboratory experimentation with an unrealistically small dataset. As the dataset grows, the memory requirements of sklearn (or any other solution that needs all of the data at once in memory) linearly increase, which is intractable.

The genericity and/or rigidity of sklearn makes applying domain knowledge to feature extraction difficult. Sklearn's feature extractors are generic and suboptimal. For example, sklearn's hashing encoder may cause too many false positives (e.g. collisions) during inferencing due to insufficient integration/awareness of the data. As a result, the feature extraction process can misrepresent data leading to undesirable/misleading input to downstream ML model(s). Thus, general purpose feature extraction may harm the accuracy of ML inferencing, as well as degrade time and/or space efficiency.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example computer that transcodes features into a vector according to metadata;

FIG. 2 is a flow diagram that depicts an example computer process for encoding features into a vector according to metadata;

FIG. 3 is a flow diagram that depicts an example computer scaling horizontally for accelerated transcoding of a message;

FIG. 4 is a block diagram that depicts an example computer that reuses a transcoder for equivalent fields of multiple signatures, generates synthetic tuples, and reuses transcoders to populate separate feature vectors for separate messages;

FIG. 5 is a flow diagram that depicts an example computer processing messages in various ways;

FIG. 6 is a block diagram that depicts an example computer that selects subsets of transcoders to bind according to optimization criteria, has multiple feature encodings of a same field, and has a signature dictionary for acceleration;

FIG. 7 is a flow diagram that depicts an example computer selecting subsets of transcoders to bind according to optimization criteria, generating multiple feature encodings of a same field, and reading a signature dictionary for acceleration;

FIG. 8 is a block diagram that depicts an example computer that combines value ranges of equivalent fields and selects transcoders based on suitability score;

FIG. 9 is a flow diagram that depicts an example computer combining value ranges of equivalent fields and selecting transcoders based on suitability score;

FIG. 10 is a block diagram that illustrates a computer system upon which an embodiment of the invention may be implemented;

FIG. 11 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein are computerized techniques for efficient and modular transcoding of message fields into features for inclusion within a feature vector. Techniques herein facilitate capturing and encoding of as much relevant semantic information as possible into feature vectors for consumption by subsequent machine learning (ML) analysis. The ability to rapidly introduce and assess new domain knowledge injectors, data transformations, and numeric encoding schemes allows novel systems herein to be rapidly extended and retargeted to new and specialized data sources and use cases. These systems can operate in a streaming fashion and concurrently to maximize throughput. Message schema information that describes input formats may be utilized for flexibility and/or acceleration.

Domain knowledge injection into the features is done through modules called transcoders which encapsulate application-specific heuristics, data transformations, and encoding strategies. Designs herein provide isolated development of transcoders within a sandbox to minimize coupling with the rest of the system and other transcoders. That facilitates rapid development, testing, and deployment that reduces time to market of new embodiments.

Some transcoders can add new information fields into a log message. That facilitates log enrichment during feature extraction. In various approaches for machine learning pipelines, log enrichment is a separate phase of the pipeline, and typically done in an ad hoc manner.

Another technological improvement is a mechanism for processing an incoming log message to generate the features. Highly integrated techniques herein may depend on a parser's structured output to extract features. The parser may generate a message signature dictionary that has a defined structure (e.g. template) of every log message format that the parse has already encountered. Techniques herein may use this information to build an optimized processing table for known message formats. A processing table can be used to accelerate invocation of transcoders to encode a log message into a feature vector.

Herein is a modular scheme for encoding arbitrary data into numbers that can then be used by downstream ML model(s). Addressed herein is the issue of how to efficiently convert structured data into numbers that an ML model expects. To avoid the problem of having to process large datasets all at once, the tooling herein is designed to handle whatever piecemeal data is momentarily available, thereby facilitating stream analytics. That may be more or less impossible with existing solutions such as sklearn feature extraction.

In an embodiment, a computer receives message signatures. Each signature has fields. Each field has a name and a type. A feature map is generated that associates a field name and a field type with transcoder(s). A message is received from a parser as field tuples. Each tuple has a field type, a field name, and a field value. Each tuple is processed as follows. The field name and field type of the tuple is used as a lookup key into the feature map to retrieve respective transcoder(s) that each generate a respective encoded feature from the field value of the tuple. An encoded feature from at least one relevant transcoder is written into a respective distinct location within a feature vector to encode the message. A same or downstream application makes an inference based on the feature vector.

Techniques herein improve the performance of a feature encoding computer itself in various ways. Specialized structures and heuristics may avoid inefficiencies of general purpose feature extraction as follows. Message schema information that describes input formats is utilized for flexibility and/or acceleration. For acceleration, special data structures may be prepopulated and then optimally referenced during feature encoding, including structures such as a message signature, a signature hash code, a signature dictionary, and/or a field processing table.

Specialized embeddings and other encodings may avoid inefficiencies of general purpose feature extraction to increase the accuracy of downstream ML inferencing, as well as save time and/or space when the ML operates. A highly relevant contextual embedding may be achieved to increase the inferential accuracy of a downstream ML model such as with graph embedding. The entirety or portions of feature vectors of semantically related messages may be concatenated with the current feature vector to achieve a contextual embedding. For example, a contextual embedding may then be consumed by an autoencoder (AE) and/or a recurrent neural network (RNN) for temporal/sequential inferencing such as anomaly detection.

Schematic patterns may improve the performance of a feature encoding computer itself as follows. More or less redundant (e.g. different densities) encodings of a field value may increase accuracy and/or reduce training time of a downstream AI model. Feature vectors may share a same logical schema, which field equivalence may affect. Field equivalence may achieve a denser (i.e. smaller) feature vector than other field mapping techniques, which may reduce demand for time and/or space by a computer without loss of (e.g. downstream) accuracy. However, there may be a point of diminishing returns or even degradation from too many feature alternatives. To conserve time and/or space, an embodiment may select a best subset of features to include within a feature vector according to optimization criteria.

Various forms of parallelism may reduce latency and/or increase throughput for feature encoding as follows. Multiple central processing units (CPUs) and/or processor cores can achieve horizontal scaling for accelerated transcoding. Embodiments herein facilitate multiple feature vectors being concurrently populated from separate messages without synchronization, and multiple fields and/or features being concurrently processed within a same message without synchronization. Thus, asynchrony and pipelining, within a message and/or across multiple messages, are directly facilitated.

When vector hardware such as single instruction multiple data (SIMD) is available, feature encoding may use data parallelism for a batch of messages (and their feature vectors) that share a same signature. For example, field values of tuples of a same field across messages in the batch may themselves be stored into a column vector for data parallel processing such as by SIMD or other vector hardware to achieve inelastic horizontal scaling.

### 1.0 Example Computer

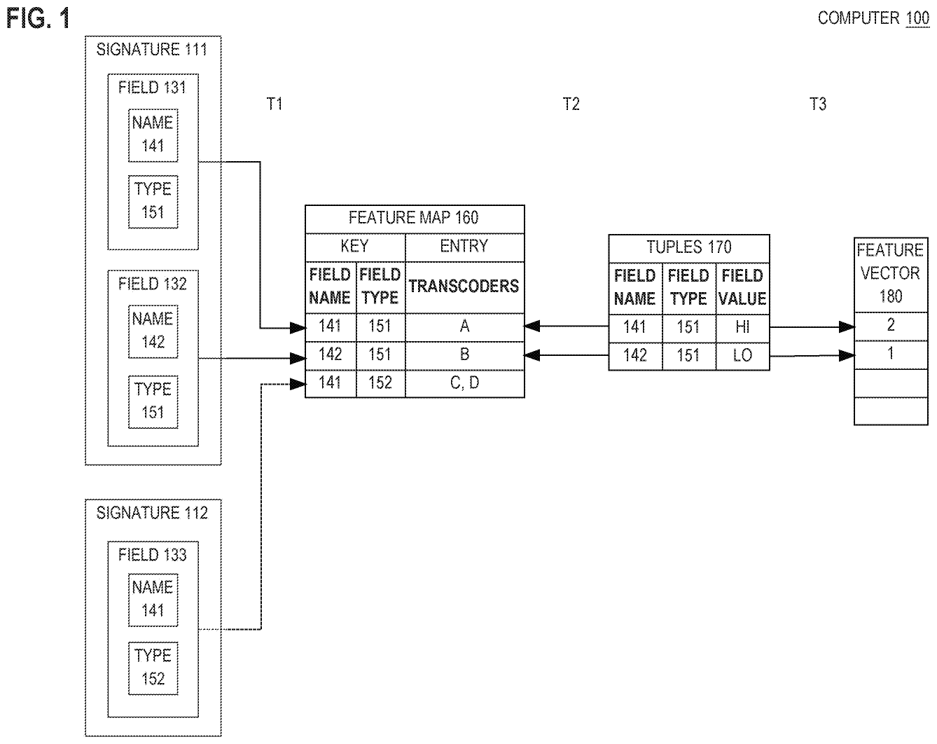

FIG. 1 is a block diagram that depicts an example computer 100, in an embodiment. Computer 100 encodes features into a vector according to metadata. Computer 100 may be one or more of a rack server such as a blade, a personal computer, a mainframe, a network element such as a packet switch, or other computing device.

Computer 100 encodes sets of tuples, such as 170, into feature vectors such as 180. Tuples 170 may represent data that was extracted from one message, record, or other data structure (not shown). Extraction may have been necessary because a message was raw and unparsed. For example, the message may consist of human readable text that is unstructured or semi-structured (e.g. a console log diagnostic message consisting primarily of natural language), inconveniently formatted (e.g. textual JavaScript object notation, JSON), or binary data that is inconveniently packed (e.g. a network packet or protocol data unit, PDU, a binary large object, BLOB, a character large object, CLOB, or a native object graph such as loaded or serialized).

Computer 100 may process a high volume of messages, such as delivered in a stream, a batch, a file, or a query result set (not shown). Tuples 170 may be generated by a parser (not shown) from one message (not shown). In an embodiment, computer 100 hosts the parser. In an embodiment, computer 100 receives tuples 170 already parsed.

Tuples 170 is shown as a table, and each row is a separate tuple from a same message. Each tuple represents a separate field from the same message. For example, a diagnostic message in a console log may have been generated by a formatted print (printf) statement that embedded field values into the message. Thus, a message may be composed of variable values and invariant substrings, both of which the parser may extract and individually convert into separate tuples.

A textual message such as “There are 2 errors!” may be parsed into, for example, three tuples that represent respective fragments of the message such as “There are”, “2”, and “errors!”. The parser may generate some or all tuples as raw text or as encoded (e.g. parsed and/or hashed) values. For example, the message fragment “2” may be encoded as a native integer.

Likewise, a fragment such as “July” may be parsed into an integer ordinal of enumerated months. For example, the field value column of tuples 170 may contain a numeric zero (not shown) as converted from January as a zero-based month. Indeed, the word January may or may not be discarded by the parser after encoding into tuples 170 as an integer. In some cases, a field value may contain a file path or uniform resource identifier (URI) such as a uniform resource locator (URL) that may be dereferenced to retrieve an actual field value. The retrieved object may be parsed as if it were originally available in a tuple of the message as a raw value.

As shown, tuples 170 has three columns. The field value column contains an extracted (e.g. encoded or raw) value of a message fragment. The field name column indicates a meaning of the field. In an embodiment, the field name is textual, such as “age”. In the shown embodiment, the field name is an integer, such as an enumeration ordinal or an array index, that may implicitly correspond to a textual name.

Likewise, the field type column may be textual or a corresponding ordinal integer. Field type indicates a data type. The data type may be a primitive such as a signed or unsigned integer of a given width (e.g. byte, short, word, long), or a floating point number of a given width. The data type may be an enumeration of ordinal integers such as a month or other category. The data type may be a raw text variable. The data type may be a particular string constant (i.e. literal).

In an embodiment, some fields do not have names, and the ordinal position of the fragment within the message may serve as the field name. For example, a second field may have an implied name of “2”. A field name need not be a globally unique identifier of a field. For example, different kinds of messages may (e.g. accidentally or intentionally) reuse a same field name. Computer 100 may treat identically named fields as different if their field types are different, or treat them as equivalent fields if their names and types are identical. Thus, a field may be more or less identified according to a pairing of the field's name and type.

In an embodiment, some field names are reused for multiple fields within a same message. If the field types differ, then the field name collision is irrelevant. If the field types are identical, then the fields may be renamed, such as by appending an ordinal position of the field onto the field name to achieve distinct field names.

The parser (not shown) may also expose message signatures such as 111-112. Each signature represents a template for more or less similar messages. For example, messages “There are 2 errors!” and “There are 3 errors!” may have a same signature, whereas “Checking queues.” may have a different signature. Each signature has at least one field, and different signatures may have a same or different amount of fields.

Each field has a type, and fields may share a type. The field type of each of tuples 170 should refer to a type of a field of a signature. Each field has a natural or (i.e. as explained above) synthetic name. Fields of different signatures may share a name. The field name of each of tuples 170 should refer to a name of a field of a signature. For example, the bottom row of tuples 170 bears the name and type of field 132.

Computer 100 operates as follows according to times T1-T3 that sequentially occur. Operation during T1 is preparatory and populates feature map 160 with metadata that binds fields to transcoders as follows based on signatures. A transcoder is a software module that converts parsed values of one field into a feature that is readily embedded amongst other features within a feature vector such as 180. There may be a one-to-one correspondence between some fields and some features. Some fields may have many or no features within feature vector 180.

Depending on the embodiment, each feature within feature vector 180 is encoded as a respective datatype or all features have a same type. Examples of an encoded feature datatype include one or more real numbers of a precision, such as single or double, and/or integer(s) of a (e,g, same) machine width, such as byte, short, word, or long. For example, feature vector 180 may be a one-dimensional vector of integers or of doubles.

Each row of feature map 160 binds a same field of one or more signatures to at least one transcoder such as A-D. Each row contains a lookup key and an entry set. The key is a compound key that contains a name and type of a field of one signature or equivalent fields of multiple signatures. The entry is a set of at least one transcoder. For example, field 133 is bound to transcoders C-D according to the bottom row of feature map 160.

In an embodiment, feature map 160 is hard (e.g. hand) coded. In an embodiment, feature map 160 is externalizable and may be marshalled to and from a file, such as an object serialization file, an extensible markup language (XML) file, or a spreadsheet. In another embodiment, feature map 160 is automatically populated as follows.

Initially, all transcoders and fields are unbound. Computer 100 obtains signatures 111-112 (e.g. from the parser). Each field of each signature is provided to each transcoder. Each transcoder indicates whether or not it can parse that field. For example, only transcoders C-D can parse field 133, which is then recorded as a row within feature map 160.

In an embodiment, a transcoder reports its ability to handle a field as a (e.g. numeric) score that indicates suitability. For example, an unsigned integer transcoder is better suited to process unsigned integers than is a signed integer transcoder or a floating point transcoder, although all three transcoders may be able to do so. For example, the unsigned integer transcoder would report the highest suitability score. Whereas, a color transcoder might be unable to handle numbers and may have a score of zero that indicates a complete inability to process numbers. For example, only transcoders with a score that exceeds zero or a threshold for a field are recorded as bound to that field within feature map 160. Additional aspects of associating (e.g. multiple) transcoders with a field are discussed later herein.

Times T2-T3 entail tuple processing, such as for live (e.g. real time) messages. At time T2, tuples 170 of a parsed message is received and analyzed, which entails individually inspecting each tuple (i.e. row) of tuples 170. The name and type of a tuple are used together as a compound lookup key for retrieving a set of transcoders from feature map 160.

Vectorization of tuples 170 occurs at time T3, which entails transcoding values into feature vector 180. For example, transcoder A converts tuple value HI (e.g. text) into an integer 2, which is then stored into the top item of feature vector 180. In an embodiment, additional metadata (not shown) indicates at which location within feature vector 180 should a result value generated by a transcoder be stored.

In an embodiment, analysis at time T2 occurs for all tuples of tuples 170. Then at time T3, transcoding and storing into feature vector 180 occurs for all tuples. In another embodiment, tuples are fully processed individually, such that processing at times T2-T3 occurs for one tuple and times T2-T3 are subsequently repeated for a next tuple of tuples 170.

Multiple central processing units (CPUs) and/or processor cores can achieve horizontal scaling for accelerated transcoding. One core may transcode and store within feature vector 180 an encoding of one tuple of tuples 170 while another core concurrently transcodes another tuple. In an embodiment, each core may process a distinct subset of tuples of tuples 170 as a batch.

In an embodiment, feature vector 180 may reside in shared memory and be concurrently populated by multiple cores. In an embodiment, feature vector 180 is concurrently written more or less without synchronization because cores write disjoint (i.e. non-overlapping) subsets of tuples 170. For example, a shared synchronization barrier at the end of time T3 for all cores may be sufficient, as needed only to detect when feature vector 180 is fully populated.

### 2.0 Example Transcoding Process

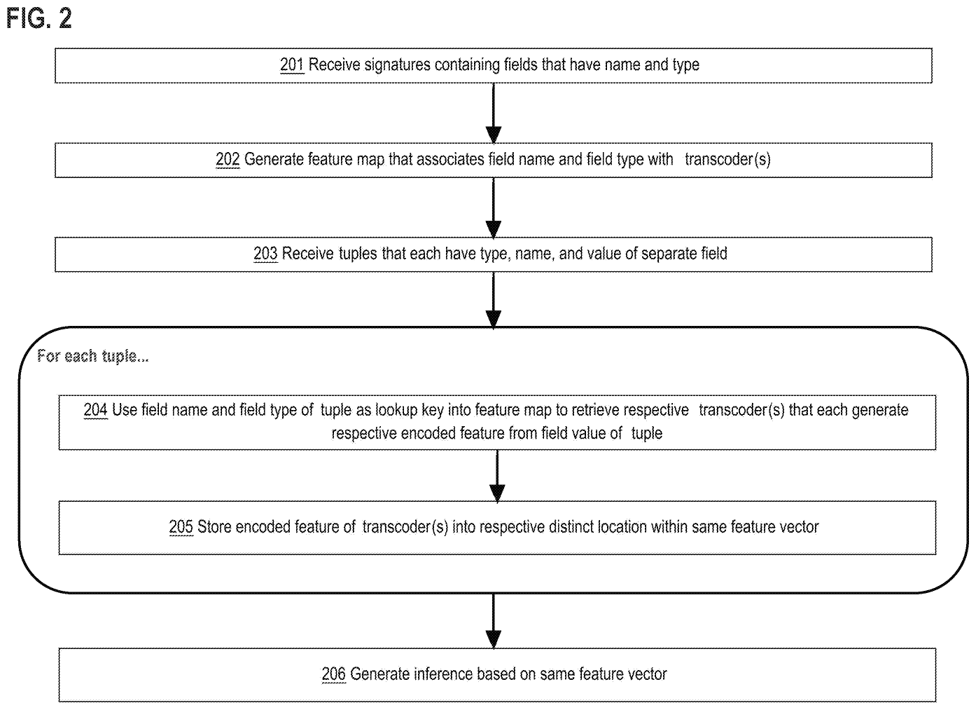

FIG. 2 is a flow diagram that depicts computer 100 encoding features into a vector according to metadata, in an embodiment. FIG. 2 is discussed with reference to FIG. 1.

Steps 201-202 are preparatory, need only occur once, and may occur at shown time T1 that may occur during system initialization. Step 201 obtains message schema metadata, perhaps from a message parser or from a configuration file. That metadata includes message signatures, each of which contains a sequence of fields that are more or less identified by name and type. For example, computer 100 receives signatures 111-112 and their constituent fields from a parser (not shown) that converts each message (not shown) into tuples such as 170.

Step 202 generates a feature map from the message signatures and/or other metadata obtained from the parser. The feature map binds transcoder(s) to each distinct pair of field name and field type, which is a compound key of equivalent field(s) as explained above. For example, details of message signatures 111-112 and other metadata is used to populate feature map 160.

Upon finishing step 202, computer 100 is fully configured and ready to transcode messages into feature vectors. Steps 203-206 may be (e.g. concurrently) repeated for each message of a batch or stream, and each message populates a separate feature vector. Step 203 obtains tuples of a next message, such as from a message parser. For example, computer 100 may have an embedded parser that is invoked to parse a next message and generate tuples 170. In step 203, a signature of the message may be identified more or less directly from tuples 170 or the parser.

Steps 204-205 are (e.g. concurrently) repeated for each tuple (i.e. field) in tuples of the message. Step 204 uses the name and type of the field of the next tuple as a compound lookup key to identify transcoder(s) that accept the value of the field. For example at shown time T2, a row of tuples 170 may be the next tuple, from which a compound lookup key may be extracted and/or synthesized. Using the lookup key within feature map 160 identifies one or more transcoders for the current field. For acceleration, step 204 may additionally or instead use the message signature or its details to retrieve a processing table of fields and their transcoders.

Transcoder(s) of the current field are invoked in step 204 with a same value of the field. For example, either transcoder A or B is invoked, depending on which row of tuples 170 has the current field. Transcoding converts the field value into an encoded feature.

Step 205 writes the encoded feature into its own reserved space within a feature vector. For example, feature vector 180 consists of multiple slots that may each store a value of a separate feature. The encoded feature of the current field is written into the corresponding slot of the feature vector. For example at shown time T3, the field value of the bottom row of tuples 170 is converted by transcoder B into value 1 that is written into the second slot of feature vector 180. For example, feature map 160, tuples 170, and feature vector 180 may be data structures within volatile memory.

Upon finishing steps 204-205 for all tuples (i.e. fields) of the current message, feature vector 180 is fully populated with encoded features. Step 206 may provide feature vector 180 to a data sink such as a file or a downstream consumer such as a trained message-analyzer artificial intelligence (AI) that may make an inference based on the content of feature vector 180. For example, the AI may detect that feature vector 180 is anomalous, which may indicate a malfunction of a network element or service (e.g. an application) or a security attack. Other examples may use feature vector analysis for other purposes, with or without AI.

### 3.0 Another Example Transcoding Process

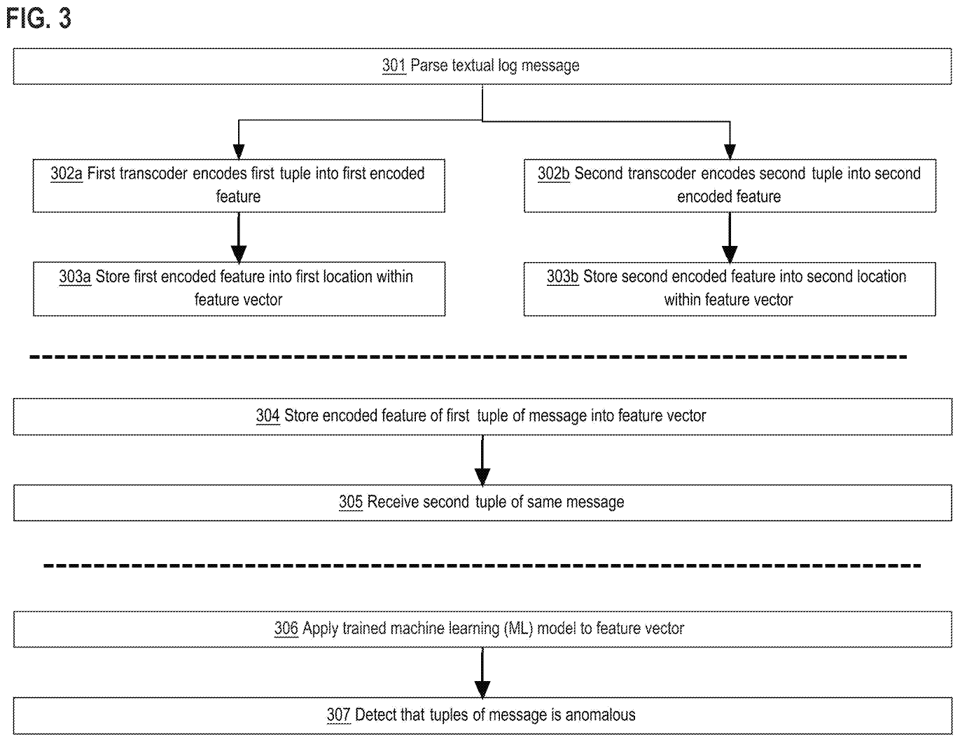

FIG. 3 is a flow diagram that depicts computer 100 processing messages in various ways, in an embodiment. FIG. 3 is discussed with reference to FIG. 1. The bold dashed horizontal lines separate FIG. 3 into three distinct flows that each occur for a different scenario. The three flows of FIG. 3 may be combined in some cases.

The top flow of FIG. 3 depicts computer 100 scaling horizontally for accelerated transcoding of a message. Step 301 parses a next message into tuples that represent fields. For example, computer 100 may embed or connect to a message parser to parse a next line of text of a (e.g. live or previously recorded console log) into tuples 170.

Subsets of tuples or individual tuples may be processed by separate execution contexts such as threads and/or processing cores. Because data structures 111-112, 160, and 170 may be read only during message processing, those data structures are inherently thread safe. Thus, steps 302a-b may be concurrent also because they do not share a transcoder. Although steps 303a-b write to a same feature vector, those steps may be concurrent because they are spatially isolated because they do not write to a same location within the feature vector.

If vector hardware (not shown) such as single instruction multiple data (SIMD) is available, data parallelism may be achieved for steps 302 and/or 303 for a batch of messages (and their feature vectors) that share a same signature. For example, field values of tuples of a same field across messages in the batch may themselves be stored into a column vector (not shown) for data parallel processing such as by SIMD or other vector hardware to achieve inelastic horizontal scaling.

Some embodiments may have synchronization barriers, such as before or after steps 302 or 303. However, the only synchronization inherently needed is a barrier that detects when a particular feature vector has finished populating with all of its features. Thus, multiple feature vectors may concurrently populate from separate messages without synchronization, and multiple fields and/or features may be concurrently processed within a same message without synchronization. Thus, asynchrony and pipelining, within a message and/or across multiple messages, are encouraged for increasing throughput.

The middle flow of FIG. 3 depicts pipeline parallelism that is naturally suited for asynchrony and/or message streaming. For example, computer 100 may transcode continuously or in computational bursts, with confounding factors such as buffering, batching, network weather, and/or demand spikes of communication or processing by a same or unrelated application. Computer 100 need not wait for more tuples when at least some pending tuple(s) are already available.

A message may be inconveniently split (e.g. into different buffers) such that only some of its tuples are available. Step 304 may process one tuple of a message before step 305 receives another tuple of the same message, which achieves (e.g. asynchronous) pipelining. Thus, receipt and transcoding may be decoupled and may overlap for multiple tuples of a same or different message.

The bottom flow of FIG. 3 depicts downstream consumption of an already populated feature vector, such as by a same or different application. Step 306 applies a trained machine learning (ML) model to a feature vector to achieve some inference or other analysis. For example, feature vector 180 may be injected as input into an artificial neural network (ANN).

In an embodiment, each feature value within feature vector 180 may be a number that is applied to a separate individual neuron of an input layer of a multilayer perceptron (MLP). In an embodiment, each bit of a one hot sparsely encoded feature may be applied to a separate individual neuron of the input layer. In an embodiment, each feature vector represents an isolated message that may be consumed downstream without regard for other (e.g. logically or temporally related) messages.

In an embodiment, related messages (i.e. feature vectors) may provide context for more accurate analysis of a current message's feature vector by an ML model. In an embodiment, a temporal window (not shown) that slides over a message sequence (e.g. live stream) may identify messages (not shown) that are slightly older and/or younger than the current message. The entirety or portions of feature vectors of such related messages may be concatenated with the current feature vector to achieve a contextual embedding that may facilitate analysis of (e.g. anomalies in) time series data. For example, a contextual embedding may then be consumed by an autoencoder (AE) and/or a recurrent neural network (RNN) for temporal/sequential inferencing such as anomaly detection such as network intrusion alerting.

In an embodiment, contextual embedding is achieved by graph embedding. For example, in addition to or instead of relating messages by temporal adjacency, field values of (e.g. temporally distant) messages may be correlated (i.e. matched) to achieve an aggregation of semantically related messages. For example, multiple messages may have different signatures but share a field value for a same field type, with or without a same field name. For example, multiple messages may contain a same internet protocol (IP) address and then be correlated, even if one message names its field as SOURCE ADDRESS and another message names a similar field as ADDRESS.

Semantically related messages may become connected into a logical graph (not shown) of limited (e.g. small) diameter, and entireties or portions of their feature vectors may be concatenated to achieve a graph embedding of a current message. In these ways, a highly relevant contextual embedding may be achieved to increase the inferential accuracy of a downstream ML model. For example in step 307, an output layer of an MLP (not shown) may classify tuples 170 as (e.g. contextually) anomalous.

### 4.0 Transcoder Reuse

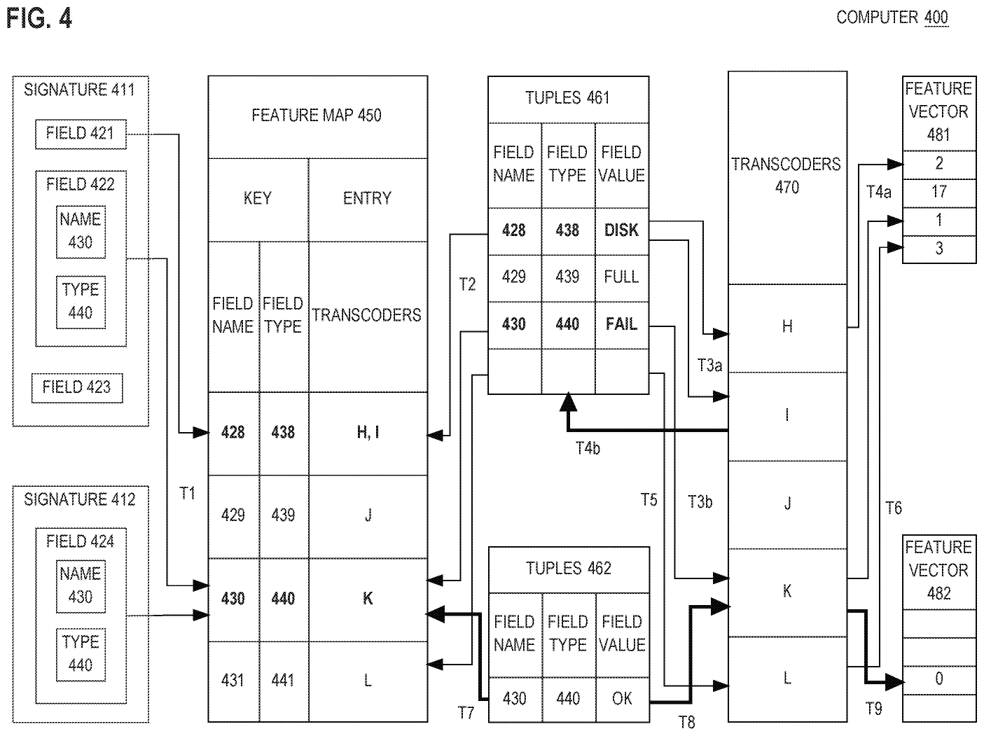

FIG. 4 is a block diagram that depicts an example computer 400, in an embodiment. Computer 400 reuses a transcoder for equivalent fields of multiple signatures, generates synthetic tuples, and reuses transcoders to populate separate feature vectors for separate messages. Computer 400 may be an implementation of computer 100.

Computer 400 operates as follows according to times T1-T9 that sequentially occur. Time T1 is preparatory. At time T1, computer 400 obtains message signatures 411-412, such as from a parser (not shown). Although not shown as such, signature field 421 has name 428 and type 438. Also not shown are a name and type of field 423.

At time T1 the signature fields are bound within feature map 450 to transcoders, such as H-L, according to techniques described above. Fields 422 and 424 of respective signatures 411-412 have same name 430 and type 440. Thus, fields 422 and 424, despite occurring at different sequential positions within their respective signatures 411-412, are bound to same transcoder(s) K. Feature map 450 becomes fully populated during time T1.

Times T2-T6 process a first message (i.e. tuples 461) that conforms with signature 411 to populate feature vector 481 as follows. At time T2, name 428 and type 438 of the top row (i.e. tuple) of tuples 461 is used as a lookup key into feature map 450 to identify multiple transcoders H-I. Transcoders H-I are accessed within transcoders 470 and applied to field value DISK at time T3a, and transcoder K is accessed and applied to field value FAIL at time T3b, which may be more or less a same time as time T3a. For example, if tuples are processed in parallel, then times T3a-b may be a same time. Otherwise, times T3a-b may occur sequentially.

Thus, times T3a-b generate feature encodings for fields 421-422 (and perhaps 423). Whereas, time T4a writes those feature encodings into feature vector 481. For example, transcoder H encodes field value DISK as feature value 2, and transcoder K encodes field value FAIL as feature value 1, with concurrency achieved or not according to the embodiment.

At time T4b (perhaps concurrent to time T4a), transcoder I processes field value DISK. However, transcoder I does not emit an encoded feature. Instead, transcoder I synthesizes a new tuple that is appended into tuples 461.

Thus, tuples 461 needs an additional phase of transcoding to process synthetic tuples of tuples 461. For example at time T5 and according to feature map 450, transcoder L encodes the synthetic tuple as feature value 3 that is written into feature vector 481 at time T6. Upon completion of time T6, processing of tuples 461 is finished, and feature vector 481 is fully populated and may be sent downstream (not shown) for subsequent consumption.

Times T7-T9 process a second message (i.e. tuples 462) that conforms with signature 412 to populate feature vector 482 as follows. At time T7, transcoder K is looked up within feature map 450. At time T8, transcoder K is reused to encode field value OK as feature value 0, which is written into feature vector 482 at time T9.

In the shown embodiment, feature vectors 481-482 have a same length and encode a same amount of features, such as the union of all features that can be generated from all message signatures. For example if transcoding tuples 462 does not fully populate feature vector 482, then some field values within feature vector 482 may receive (e.g. initialized to) default values, such as a null value or other out of range value. Default values may vary by field type and/or feature type. A default value need not be out of range, and thus may be a same value as occurs naturally in a same or different field for other messages of a same or different signature.

### 5.0 Example Enrichment Process

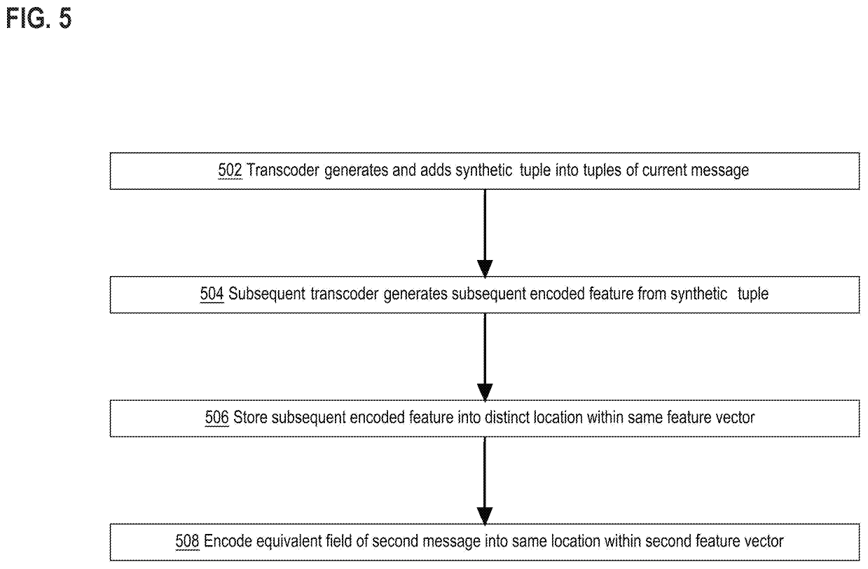

FIG. 5 is a flow diagram that depicts computer 400 processing messages in various ways, in an embodiment. FIG. 5 is discussed with reference to FIG. 4.

Steps 502, 504, and 506 process a first message in phases shown as times T1-T6. Times T1-T4a may or may not occur during step 502. Step 502 enriches tuples 461 during time T4b, which may or may not be concurrent with time T4a. In step 502, a transcoder such as I generates a synthetic tuple based on a value of a current field of a message. Transcoder I adds the synthetic tuple to tuples 461 of the current message.

During step 504 at time T5, another transcoder(s) such as L converts the synthetic tuple into an encoded feature(s). Previously at time T4a, some features were written into feature vector 481. During step 506 at time T6, feature(s) from synthetic tuple(s) are written into same feature vector 481, but at different locations within feature vector 481 such that features previously written are not lost (i.e. overwritten). Thus, time T4a directly populates some of feature vector 481, and time T6 enriches feature vector 481.

Steps 502, 504, and 506 may or may not finish transcoding a first message when step 508 transcodes a field of another message, such as when multiple messages are concurrently transcoded. Step 508 processes a second message during shown times T7-T9. The second message may or may not have a different signature than the first message. If the second message has a field that is equivalent to a field in the first message, then that field of the second message is transcoded into a different feature vector, but at a same location (e.g. offset) as the equivalent field of the first message. Thus, similar fields at same or different positions within different messages of same or different signatures may map to a same feature (i.e. same offset across all feature vectors.

Typically, all feature vectors of computer 400 share a same internal allocation of slots to features. That is, the feature vectors share a same logical schema, which field equivalence may affect. Equivalent fields should all map to a same feature(s) at same offset(s). Thus for example, twenty fields arranged into multiple message signatures may result in less than twenty features because some fields may be equivalent. Thus, field equivalence may achieve a denser (i.e. smaller) feature vector than other field mapping techniques, which may reduce demand for time and/or space by computer 400 without loss of (e.g. downstream) accuracy.

### 6.0 Redundant Features

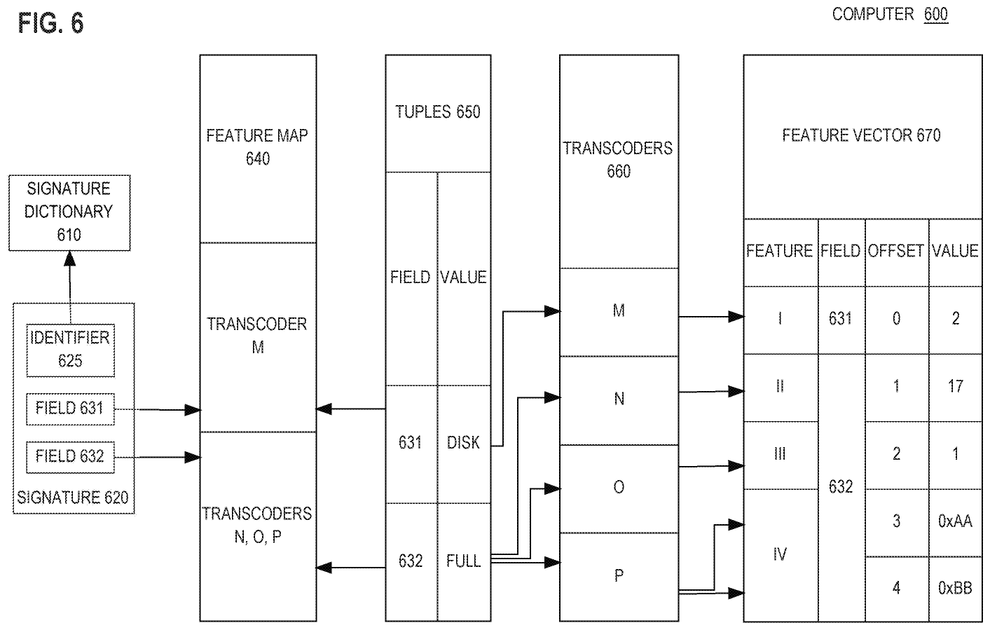

FIG. 6 is a block diagram that depicts an example computer 600, in an embodiment. Computer 600 selects subsets of transcoders to bind according to optimization criteria, has multiple feature encodings of a same field, and has a signature dictionary for acceleration. Computer 600 may be an implementation of computer 100.

Depiction of feature map 640 is abridged to show only that field 631 has transcoder M, and field 632 has multiple transcoders N, 0, and P. Depiction of feature vector 670 is embellished with implied (i.e. demonstrative) columns. Only the value column of feature vector 670 is actually stored.

In operation, a message is processed as tuples 650. Depiction of tuples 650 is abridged such that its field column is actually a pair (not shown) of columns for field name and field type. The bottom row (i.e. tuple) of tuples 650 indicates field 632 of signature 620. Thus, the message conforms to signature 620.

Although shown as a two dimensional table of rows and multiple columns, feature vector 670 is actually a one dimensional vector that stores only features in the value column. The value column stores values into a sequence of slots that are naturally indexed as an array by the offset column as shown. A field may be more or less directly transcoded into a feature that is written into one slot in the value column. For example, value DISK of field 631 is transcoded into value 2 for feature I that is written at offset 0 of the value column of feature vector 670.

Other fields may have more complex encodings into feature(s). For example, transcoders N-P convert value FULL of field 632 into respective features II-IV within feature vector 670. Thus, one field may yield multiple features. For example, two transcoders may convert a same field value into feature values of different densities. For example, one transcoder may densely encode one field as an enumeration integer, while another transcoder sparsely encodes the same field value in one hot format.

In an embodiment, slots within the value column of feature vector 670 have varied sizes. In an embodiment, slots of various sizes are unaligned (e.g. bit packed) or aligned at natural intervals such as byte or machine word.

In an embodiment, slots within the value column of feature vector 670 have a same fixed size. In an embodiment, slots have a same natural fixed size such as byte or machine word. A feature may be too big to fit within only one slot of feature vector 670. For example, a typical floating point number or short integer does not fit into a byte slot. For example as shown, field value FULL is encoded by transcoder P into feature value 0xAABB that is a short integer that needs two adjacent byte-sized slots 3-4 within the value column.

More or less redundant (e.g. different densities) encodings of a field value may facilitate downstream processing of feature vector 670 by a consumer. For example, vector 670 may be a feature embedding that is consumed as input to an artificial neural network (ANN) or other artificial intelligence (AI). Up to a point, redundant encodings may increase accuracy and/or reduce training time of a downstream AI model.

However there may be a point of diminishing returns or even degradation from too many feature alternatives. To conserve time and/or space, an embodiment may select a best subset of features to include within feature vector 670. Subset selection may occur according to criteria as follows.

In an embodiment, features may be selectively discarded (i.e. excluded from feature vector 670) until the size of feature vector 670 falls below a threshold. In an embodiment, the size of feature vector 670 is measured in features and increased by redundant features. In embodiments, the size of feature vector 670 is measured in slots, machine words, bytes, or bits. Feature vector sizing occurs during system initialization (e.g. based on metadata), after which all feature vectors such as 670 are created with a same fixed size.

In an embodiment, features are selected for discarding (i.e. exclusion) based on redundancy. For example, fields with more redundant features lose features first. For example, feature vector 670 may shrink to include only offsets 0-1 and still somewhat represent fields 631-632. In an embodiment, features are discarded based on size (e.g. sparsity). For example, a one hot encoded field having many possible values may be too wide to include within feature vector 670.

In an embodiment, computer 600 obtains signature dictionary 610 already populated from a parser (not shown). In an embodiment, computer 600 instead populates signature dictionary 610 according to metadata provided by the parser. In an embodiment, signature dictionary 610 is derived from metadata from feature map 640. Population of signature dictionary 610 may occur during system initialization. A message signature such as 620 may have identifier 625 and/or a hash code (not shown). Signature 620 contains a sequence of fields 631-632 from which a hash code that may be calculated according to techniques described in related U.S. patent application Ser. No. 16/246,765.

Depending on the embodiment, signature 620, signature identifier 625, or a hash code of signature 620 may be used as a lookup key into signature dictionary 610. For example, a parser may provide such a lookup key with each parsed message. For example, tuples 650 may already be associated with a lookup key.

From signature dictionary 610, a lookup key may retrieve a signature's associated processing table (not shown), which is metadata that accelerates message transcoding by providing a set of transcoders for each field of a signature. The processing table may be somewhat redundant to feature map 640. However, acceleration occurs because the processing table has already gathered each field's transcoder(s), which otherwise would need lookup within feature map 640 by name and type of field. In an embodiment, a processing table is a more or less two dimensional structure with one row per signature and each row having a set of transcoders for each field.

### 7.0 Example Transcoder Selection Process

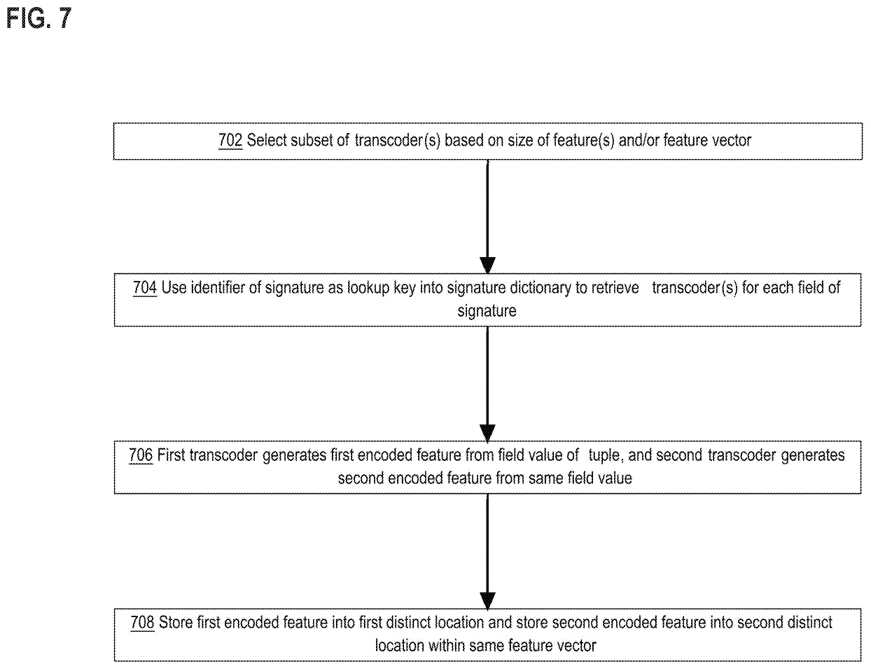

FIG. 7 is a flow diagram that depicts computer 600 selecting subsets of transcoders to bind according to optimization criteria, generating multiple feature encodings of a same field, and reading a signature dictionary for acceleration, in an embodiment. FIG. 7 is discussed with reference to FIG. 6.

Step 702 is preparatory, may occur during system initialization, and need occur only once. Step 702 may occur while building feature map 640 that enumerates which transcoder(s) accept each field. For example, many transcoders may be more or less able to accept the value range of a same field such as 632.

On one hand, more transcoders of a same field means more encodings (i.e. features) of that field, which may increase downstream accuracy. On the other hand, redundant features within feature vector 670 need more time and space. Thus, there is a design tension, over which (e.g. redundant) features are excluded from feature vector 670, that may by more or less optimized by heuristics, mathematical solvers, and/or AI. For example, feature exclusion may be optimized as hyperparameters.

In an embodiment, features are excluded (e.g. by threshold) from feature vector 670 based on size, quantity, and redundancy of features, and/or (e.g. ideal) size of the feature vector. For example, a one hot sparsely encoded feature and/or a megabyte feature vector may be too big. The transcoders of excluded features are themselves excluded from feature map 640. In an embodiment, transcoders are suitability scored for a field, and transcoders are excluded from feature map 640 based on absolute or relative score. Suitability scoring is discussed later herein.

In operation, step 704 is preparatory and may be repeated for each message. Step 704 detects which signature is associated with the current message, such as reported by the parser (not shown). For example, step 704 uses signature 620, signature identifier 625, or a hashing of the signature as a lookup key into signature dictionary 610 to retrieve a processing table that binds respective transcoder(s) to each field 631-632 of signature 620. The processing table accelerates subsequent step 706.

Steps 706 and 708 may be repeated for each message that generates redundant features from a same field. Step 706 uses redundant (i.e. multiple) transcoders of a same field, as specified in the processing table. For example, transcoders N-P convert value FULL of field 632 into redundant features II-IV. Step 708 writes redundant features II-IV into respective distinct offsets 1-4 of feature vector 670.

### 8.0 Suitability Scoring

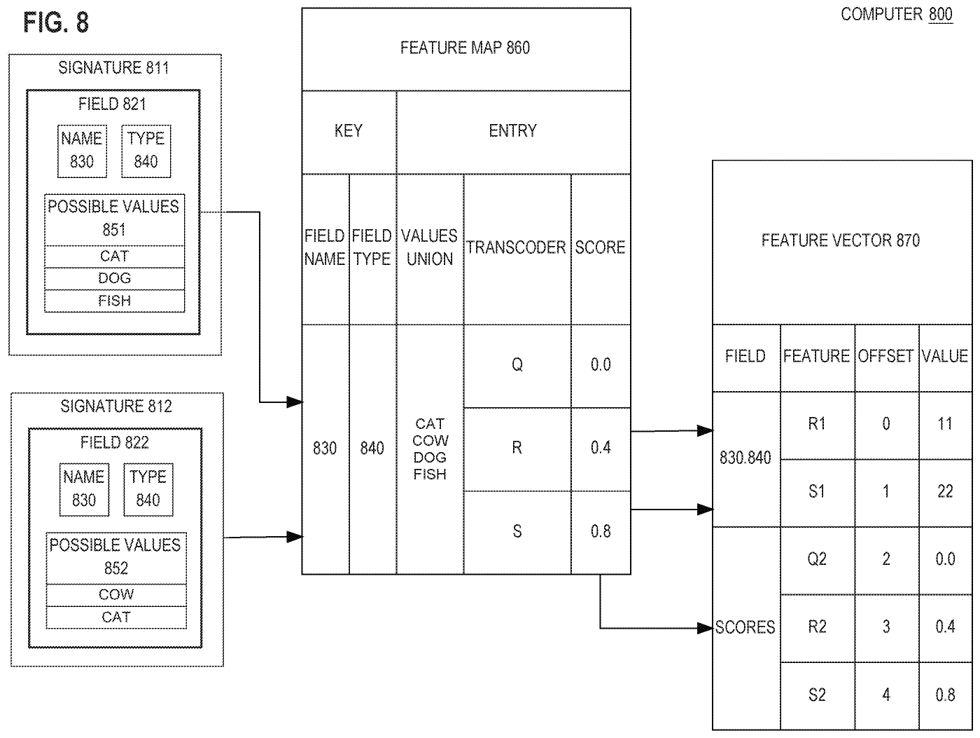

FIG. 8 is a block diagram that depicts an example computer 800, in an embodiment. Computer 800 combines value ranges of equivalent fields and selects transcoders based on suitability score. Computer 800 may be an implementation of computer 100.

As explained earlier herein, fields are equivalent when their names and types match. In many scenarios, equivalent fields may be treated as a same single field. In an embodiment, signatures and their fields are inferred by example. For example, fields may be discovered during parser training from a corpus of training messages of various signatures and fields as discussed in related U.S. patent application Ser. No. 16/246,765.

A consequence of inferred signatures and fields is that equivalent fields may be observed to have different value ranges. For example, field 821 has possible values 851, and equivalent field 822 has possible values 852. Possible values 851-852 only partially overlap.

In an extreme case (not shown), possible values 851-852 may be disjoint (i.e. have no values in common). In any case, transcoder selection for equivalent fields 821-822 may be inadequate if a full range of possible values is not considered. Thus, transcoder selection may be based on the values union column of feature map 860 that merges possible values 851-852 into a combined range of distinct possible values. As explained earlier herein, selection of only a subset of available features and/or transcoders may be needed to keep feature vector 870 compact.

During system initialization, the score column of feature map 860 may become populated as follows. Feature map 860 indicates that transcoders Q-S can translate equivalent fields 821-822. The values union of equivalent features may be submitted to transcoders Q-S for suitability scoring. Transcoders Q-S inspect the values union and respond with a score that indicates how suitable is that transcoder for handling all values in the values union.

For example if the values union contained only positive integers, then a unsigned integer transcoder would score higher than a signed integer transcoder. Some transcoders may be appropriate for possible values 852 but not for 851. For example, transcoder S may accept vertebrates, while transcoder Q only accepts mammals.

In that case, transcoder Q cannot accept all of the values union, in which case transcoder Q is unsuitable and should score very low, such as zero as shown, which may be below an exclusion threshold. Thus as shown, transcoder Q does not contribute to feature vector 870. Whereas, transcoders R-S contribute respective features R1 and S1.

In an embodiment, scores of some or all transcoders are themselves features. For example as shown, scores of transcoders Q-S occur as respective features Q2, R2, and S2 within feature vector 870. In an embodiment, a score feature is encoded as a floating point number. In an embodiment, a score feature is encoded as an integer, such as a percentile. In an embodiment, possible subranges of a score are assigned integer ordinals for feature encoding.

In an embodiment, only redundant features (i.e. from a same field) have their scores encoded as features. In an embodiment, an excluded transcoder such as Q does not have its score encoded as a feature. In an embodiment, a score feature represents transcoder suitability for the values union of equivalent features. In an embodiment, a score feature represents transcoder suitability for an actual field value of a current message (not shown).

### 9.0 Example Scored Selection Process

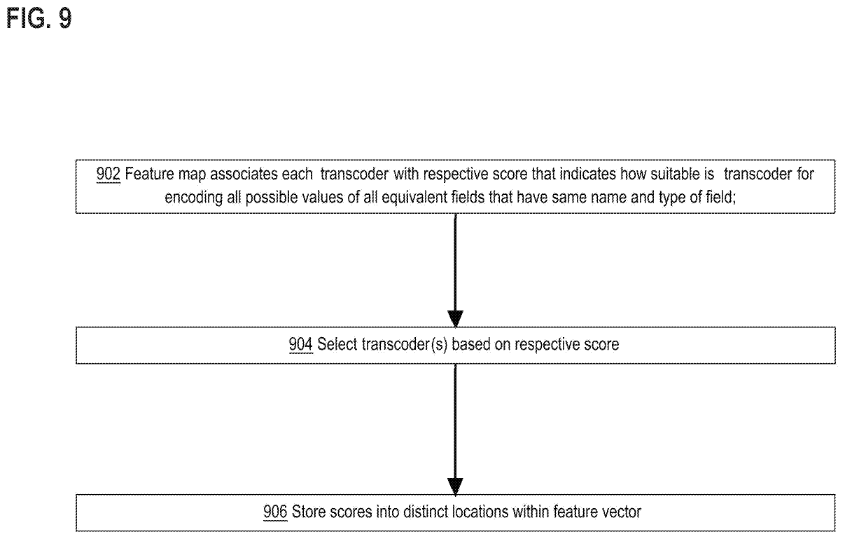

FIG. 9 is a flow diagram that depicts computer 800 combining value ranges of equivalent fields and selecting transcoders based on suitability score, in an embodiment. FIG. 9 is discussed with reference to FIG. 8.

Steps 902 and 904 are preparatory, may occur during system initialization, and need occur only once. Steps 902 and 904 are shown as separate steps but may occur together or actually describe a same activity. Step 902 builds feature map 860 by: a) binding respective transcoder(s) to each field, b) combining value ranges of equivalent fields, and c) obtaining and recording a suitability score for each relevant transcoder for the combined value range. Scoring may be delegated to the transcoders themselves.

Step 904 decides which transcoders of the equivalent field to exclude from contributing features into feature vector 870. Excluded transcoders are excluded from feature map 860.

Step 906 may be repeated for each message, regardless of signature, that has a given equivalent field. Step 906 writes scores of field's transcoders as if each score were an ordinary feature. Scores may be based on a range of possible values during system initialization or an actual field value of a current message. Treating scores as features may further occur as discussed above.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

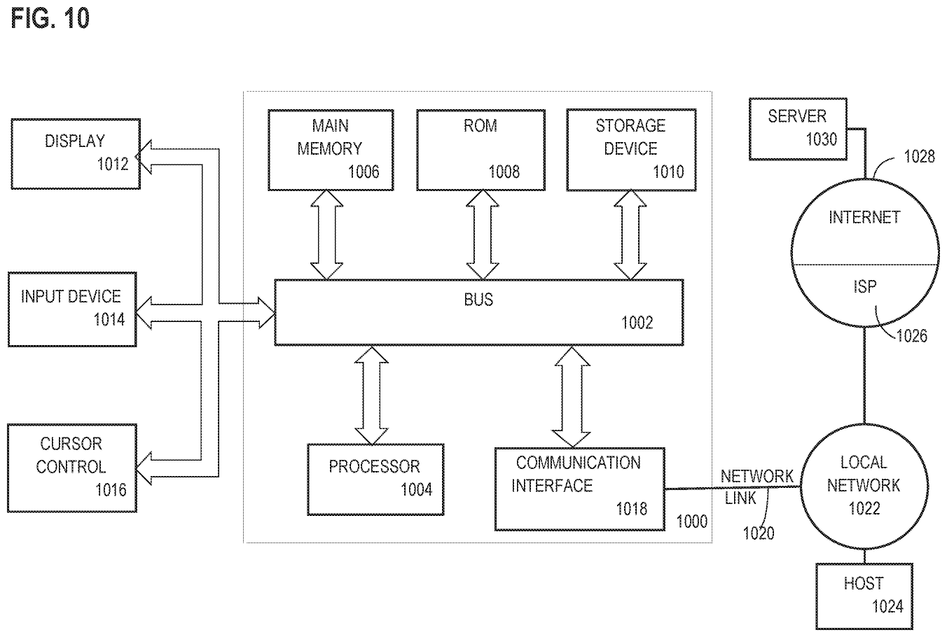

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

### Software Overview

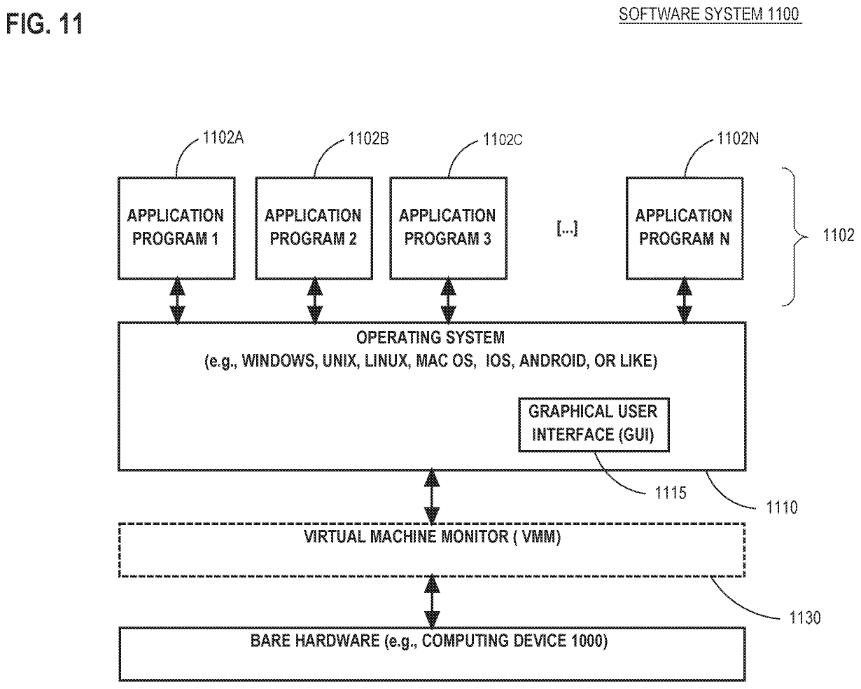

FIG. 11 is a block diagram of a basic software system 1100 that may be employed for controlling the operation of computing system 1000. Software system 1100 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1100 is provided for directing the operation of computing system 1000. Software system 1100, which may be stored in system memory (RAM) 1006 and on fixed storage (e.g., hard disk or flash memory) 106, includes a kernel or operating system (OS) 1110.

The OS 1110 manages low-level aspects of computer operation, including managing execution of processes, memory allocation, file input and output (I/O), and device I/O. One or more application programs, represented as 1102A, 1102B, 1102C . . . 1102N, may be “loaded” (e.g., transferred from fixed storage 106 into memory 1006) for execution by the system 1100. The applications or other software intended for use on computer system 1000 may also be stored as a set of downloadable computer-executable instructions, for example, for downloading and installation from an Internet location (e.g., a Web server, an app store, or other online service).

Software system 1100 includes a graphical user interface (GUI) 1115, for receiving user commands and data in a graphical (e.g., “point-and-click” or “touch gesture”) fashion. These inputs, in turn, may be acted upon by the system 1100 in accordance with instructions from operating system 1110 and/or application(s) 1102. The GUI 1115 also serves to display the results of operation from the OS 1110 and application(s) 1102, whereupon the user may supply additional inputs or terminate the session (e.g., log off).

OS 1110 can execute directly on the bare hardware 1120 (e.g., processor(s) 1004) of computer system 1000. Alternatively, a hypervisor or virtual machine monitor (VMM) 1130 may be interposed between the bare hardware 1120 and the OS 1110. In this configuration, VMM 1130 acts as a software “cushion” or virtualization layer between the OS 1110 and the bare hardware 1120 of the computer system 1000.

VMM 1130 instantiates and runs one or more virtual machine instances (“guest machines”). Each guest machine comprises a “guest” operating system, such as OS 1110, and one or more applications, such as application(s) 1102, designed to execute on the guest operating system. The VMM 1130 presents the guest operating systems with a virtual operating platform and manages the execution of the guest operating systems.

In some instances, the VMM 1130 may allow a guest operating system to run as if it is running on the bare hardware 1120 of computer system 1100 directly. In these instances, the same version of the guest operating system configured to execute on the bare hardware 1120 directly may also execute on VMM 1130 without modification or reconfiguration. In other words, VMM 1130 may provide full hardware and CPU virtualization to a guest operating system in some instances.

In other instances, a guest operating system may be specially designed or configured to execute on VMM 1130 for efficiency. In these instances, the guest operating system is “aware” that it executes on a virtual machine monitor. In other words, VMM 1130 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, executed, and/or as generating an output or predication, a computer system process executing a machine learning algorithm applies the model artifact against the input to generate a predicted output. A computer system process executes a machine learning algorithm by executing software configured to cause execution of the algorithm.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programming languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake a I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptrons (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Autoencoder implementation and integration techniques are taught in related U.S. patent application Ser. No. 14/558,700, entitled “AUTO-ENCODER ENHANCED SELF-DIAGNOSTIC COMPONENTS FOR MODEL MONITORING”. That patent application elevates a supervised or unsupervised ANN model as a first class object that is amenable to management techniques such as monitoring and governance during model development such as during training.

### Deep Context Overview

As described above, an ANN may be stateless such that timing of activation is more or less irrelevant to ANN behavior. For example, recognizing a particular letter may occur in isolation and without context. More complicated classifications may be more or less dependent upon additional contextual information. For example, the information content (i.e. complexity) of a momentary input may be less than the information content of the surrounding context. Thus, semantics may occur based on context, such as a temporal sequence across inputs or an extended pattern (e.g. compound geometry) within an input example. Various techniques have emerged that make deep learning be contextual. One general strategy is contextual encoding, which packs a stimulus input and its context (i.e. surrounding/related details) into a same (e.g. densely) encoded unit that may be applied to an ANN for analysis. One form of contextual encoding is graph embedding, which constructs and prunes (i.e. limits the extent of) a logical graph of (e.g. temporally or semantically) related events or records. The graph embedding may be used as a contextual encoding and input stimulus to an ANN.

Hidden state (i.e. memory) is a powerful ANN enhancement for (especially temporal) sequence processing. Sequencing may facilitate prediction and operational anomaly detection, which can be important techniques. A recurrent neural network (RNN) is a stateful MLP that is arranged in topological steps that may operate more or less as stages of a processing pipeline. In a folded/rolled embodiment, all of the steps have identical connection weights and may share a single one dimensional weight vector for all steps. In a recursive embodiment, there is only one step that recycles some of its output back into the one step to recursively achieve sequencing. In an unrolled/unfolded embodiment, each step may have distinct connection weights. For example, the weights of each step may occur in a respective column of a two dimensional weight matrix.

A sequence of inputs may be simultaneously or sequentially applied to respective steps of an RNN to cause analysis of the whole sequence. For each input in the sequence, the RNN predicts a next sequential input based on all previous inputs in the sequence. An RNN may predict or otherwise output almost all of the input sequence already received and also a next sequential input not yet received. Prediction of a next input by itself may be valuable. Comparison of a predicted sequence to an actually received (and applied) sequence may facilitate anomaly detection. For example, an RNN based spelling model may predict that a U follows a Q while reading a word letter by letter. If a letter actually following the Q is not a U as expected, then an anomaly is detected.

Unlike a neural layer that is composed of individual neurons, each recurrence step of an RNN may be an MLP that is composed of cells, with each cell containing a few specially arranged neurons. An RNN cell operates as a unit of memory. An RNN cell may be implemented by a long short term memory (LSTM) cell. The way LSTM arranges neurons is different from how transistors are arranged in a flip flop, but a same theme of a few control gates that are specially arranged to be stateful is a goal shared by LSTM and digital logic. For example, a neural memory cell may have an input gate, an output gate, and a forget (i.e. reset) gate. Unlike a binary circuit, the input and output gates may conduct an (e.g. unit normalized) numeric value that is retained by the cell, also as a numeric value.

An RNN has two major internal enhancements over other MLPs. The first is localized memory cells such as LSTM, which involves microscopic details. The other is cross activation of recurrence steps, which is macroscopic (i.e. gross topology). Each step receives two inputs and outputs two outputs. One input is external activation from an item in an input sequence. The other input is an output of the adjacent previous step that may embed details from some or all previous steps, which achieves sequential history (i.e. temporal context). The other output is a predicted next item in the sequence. Example mathematical formulae and techniques for RNNs and LSTM are taught in related U.S. patent application Ser. No. 15/347,501, entitled “MEMORY CELL UNIT AND RECURRENT NEURAL NETWORK INCLUDING MULTIPLE MEMORY CELL UNITS.”

Sophisticated analysis may be achieved by a so-called stack of MLPs. An example stack may sandwich an RNN between an upstream encoder ANN and a downstream decoder ANN, either or both of which may be an autoencoder. The stack may have fan-in and/or fan-out between MLPs. For example, an RNN may directly activate two downstream ANNs, such as an anomaly detector and an autodecoder. The autodecoder might be present only during model training for purposes such as visibility for monitoring training or in a feedback loop for unsupervised training. RNN model training may use backpropagation through time, which is a technique that may achieve higher accuracy for an RNN model than with ordinary backpropagation. Example mathematical formulae, pseudocode, and techniques for training RNN models using backpropagation through time are taught in related W.I.P.O. patent application No. PCT/US2017/033698, entitled “MEMORY-EFFICIENT BACKPROPAGATION THROUGH TIME”.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a plurality of signatures, wherein each signature has a plurality of fields, wherein each field has a name and a type;
generating a feature map that associates a field name and a field type with one or more transcoders;
receiving a plurality of tuples, wherein each tuple has a field type, a field name, and a field value;
for each tuple of the plurality of tuples:
using the field name and field type of the tuple as a lookup key into the feature map to retrieve respective one or more transcoders that each generate a respective encoded feature from the field value of the tuple, and
storing said encoded feature of at least one transcoder of the respective one or more transcoders into a respective distinct location within a same feature vector;
generating an inference based on the same feature vector;
wherein the method is performed by one or more computers.

2. The method of claim 1 wherein receiving the plurality of tuples comprises parsing a textual log message.

3. The method of claim 1 wherein generating the inference comprises:
detecting that the plurality of tuples is anomalous, and/or
applying a trained machine learning model to the same feature vector.

4. The method of claim 1 wherein said encoded feature consists essentially of one or more numbers.

5. The method of claim 1 wherein the feature map references:
a transcoder that encodes a categorical feature as an integer ordinal,
a transcoder that encodes a feature as a numeric hash code, and/or
a transcoder that dereferences a file path or a universal resource identifier (URI) to retrieve an object to encode.

6. The method of claim 1 wherein said storing said encoded feature of a first tuple of the plurality of tuples into the same feature vector occurs before receiving a second tuple of the plurality of tuples.

7. The method of claim 1 further comprising a transcoder of said one or more transcoders generating and adding a synthetic tuple into the plurality of tuples.

8. The method of claim 7 wherein:
a subsequent transcoder generates a subsequent encoded feature from the synthetic tuple;
the subsequent encoded feature is stored into the same feature vector at a distinct location that is not said respective distinct location.

9. The method of claim 1 wherein the same feature vector comprises distinct locations for fields that the plurality of tuples do not have.

10. The method of claim 1 wherein:
said plurality of tuples is a first plurality of tuples that has a first signature that has a first field;
a second plurality of tuples has a second signature that has a second field that has a same name and a same type as said first field;
the method further comprises encoding the second field into same said respective distinct location within a second feature vector.

11. The method of claim 1 wherein said at least one transcoder is selected from said one or more transcoders based on a size of said same feature vector.

12. The method of claim 1 wherein:
each field of the plurality of signatures comprises one or more possible values;
for a particular field name and a particular field type, the feature map associates each transcoder of said one or more transcoders with a respective score that indicates how suitable is the transcoder for encoding all possible values of all fields that have the particular field name and the particular field type;
said at least one transcoder is selected from said one or more transcoders based on the respective score.

13. The method of claim 12 wherein said respective scores are stored into a distinct location within said same feature vector.

14. The method of claim 1 wherein:
said at least one transcoder comprises a first transcoder that generates a first encoded feature from the field value of the tuple and a second transcoder that generates a second encoded feature from the field value of the tuple;
storing said encoded feature comprises storing the first encoded feature into a first distinct location and storing the second encoded feature into a second distinct location within the same feature vector.

15. The method of claim 1 wherein:
the plurality of tuples has a particular signature of the plurality of signatures;
the method further comprises using an identifier of the particular signature as a lookup key into a signature dictionary to retrieve said respective one or more transcoders for each field of the particular signature.

16. The method of claim 1 wherein:
each transcoder of said one or more transcoders generates a value that has a respective size;
said at least one transcoder is selected from said one or more transcoders based on the respective size.

17. The method of claim 1 wherein:
the plurality of tuples comprises a first tuple and a second tuple;
the method further comprises concurrently performing:
a first transcoder encoding the first tuple into a first encoded feature and a second transcoder encoding the second tuple into a second encoded feature, and/or
storing the first encoded feature into a first location within said same feature vector and storing the second encoded feature into a second location within said same feature vector.

18. One or more non-transitory computer-readable media storing instructions that, when executed by one or more processors, cause:
receiving a plurality of signatures, wherein each signature has a plurality of fields, wherein each field has a name and a type;
generating a feature map that associates a field name and a field type with one or more transcoders;
receiving a plurality of tuples, wherein each tuple has a field type, a field name, and a field value;
for each tuple of the plurality of tuples:
using the field name and field type of the tuple as a lookup key into the feature map to retrieve respective one or more transcoders that each generate a respective encoded feature from the field value of the tuple, and
storing said encoded feature of at least one transcoder of the respective one or more transcoders into a respective distinct location within a same feature vector;
generating an inference based on the same feature vector;
wherein the method is performed by one or more computers.

19. The one or more non-transitory computer-readable media of claim 18 wherein the instructions further cause a transcoder of said one or more transcoders generating and adding a synthetic tuple into the plurality of tuples.

20. The one or more non-transitory computer-readable media of claim 18 wherein:
each field of the plurality of signatures comprises one or more possible values;
for a particular field name and a particular field type, the feature map associates each transcoder of said one or more transcoders with a respective score that indicates how suitable is the transcoder for encoding all possible values of all fields that have the particular field name and the particular field type;
said at least one transcoder is selected from said one or more transcoders based on the respective score.
